(19) United States
(12) Patent Application Publication
(10) Pub. No.: US 2002/0112181 A1
(43) Pub. Date: Aug. 15, 2002

(54) Multilevel secure network access system

(76) Inventor: Mark Elwin Smith, Greensboro, NC (US)

Correspondence Address: MOORE & VAN ALLEN, PLLC, 2200 W MAIN STREET, SUITE 800, DURHAM, NC, 27705, US

(21) Appl. No.: 09/735,117

(22) Filed: Dec. 12, 2000

(51) Int. Cl. H04L 9/00

(52) U.S. Cl. 713/201

(57) ABSTRACT

Multilevel secure network access system. A workstation can access information having two or more different security classifications stored on servers within networks. Servers of one security classification are isolated from servers of another security classification by each type of server being disposed within its own isolated network or network segment. A switching unit controls input device access from a workstation. Data diodes between the networks in combination with proxy software located within each network keep data isolated. The viewing of information from at least some of the networks is accomplished through so-called “thin” or “ultra-thin” client software installed on the workstation. The use of such an ultra-thin enclave client minimizes the amount of data stored on the workstation and therefore any commingling of data of different security levels at the workstation. It also allows commercial off-the-shelf (COTS) software to be used without modification.

### BACKGROUND

1. Field of the Invention

The present invention is related to computer networking. More particularly, the present invention is related to accessing information in a plurality of networks where the information is classified at different security levels. The invention allows access to information on servers in the various networks from the same client workstation without risk of compromising sensitive information by opening it to access from networks of lower security levels.

2. Description of the Problem

Computer security and information access control have become extremely important as most information records are now stored in one or more types of computer systems. In the days of the mainframe computer, security was simple. A single terminal was used to access data on a single computer system at a time. Security could be maintained through password access control, and possibly encryption if the data traversed a communication link that might be compromised. Since all data resided on the mainframe and the terminal was used for display only, once an authorized user “logged off,” any data on the mainframe was secure.

The proliferation of personal computers and workstations, and the migration to a client/server computing environment has complicated matters for a number of reasons. Most users of classified data need to access data from servers that are both secured and unsecured. In some situations, a user may need to access data at multiple security levels, for example, top secret, secret, and unclassified. In the normal client/server model, some of the data from the server is stored on the client workstation for use by a client application. If the user accesses data from servers at multiple security levels, data may be commingled, increasing the chances that the more secure data can be compromised. The client system also creates two way connections between servers, introducing a possibility that data from a server or network of a high security classification might be accessed by a user of a server or network with a lower security classification, who may not be a trusted, authorized user of the more highly classified data. What is needed is a way to allow a client workstation to access data stored on servers of different security levels without commingling the data, and without allowing any data transmission from servers of higher security levels to servers of lower security levels. Such a solution should ideally also be able to be implemented using standardized hardware to the greatest extent possible, to minimize costs.

### SUMMARY

The present invention solves the above problem by providing a multilevel secure (MLS) access system in which information on servers or other types of computer systems of multiple security levels can be accessed in a secure manner. With the present invention, servers of one classification are isolated from servers of another classification by each type of server being disposed within its own isolated network or network segment. A switching unit controls input device access from the workstation. Data diodes between the networks in combination with proxy software located within each network keeps data isolated. In addition, the viewing of information from at least some of the networks is accomplished through so-called “thin” or “ultra-thin” client software installed on the workstation and in the networks being accessed. The use of such an ultra-thin enclave client minimizes the amount of data stored on the workstation and therefore any commingling of data of different security levels at the workstation. The invention allows a user to run commercial off-the-shelf (COTS) software applications in the isolated networks.

The invention operates in a network environment that, in one embodiment, includes a workstation that accesses a plurality of networks or network segments. The workstation is directly connected only to the network or network segment of the highest security level. The workstation is connected to a switching unit that selectively routes connections for input devices to the workstation for accessing the highest security level network, or to the selected network in the case of lower security networks. Each network contains a computer system that can run applications under the control of the workstation. The applications in at least the lower security level networks, and possibly in all the networks, run in a remotable session. Each network also contains a diode server connected to the switching unit. The diode server includes software that allows it to act as a proxy to connect the switching unit to a remotable session on an application server in the selected network. The diode server also forwards output from the remotable session to the network of the highest security level for display in a remote session viewer at the workstation, which acts as an ultra-thin client. Data diodes are disposed one each between a diode server in one of the lower security level networks and a diode server in the network of the highest security level so that information can flow only from the lower security level network to the network of the highest security level. In one embodiment, hardware diodes are used. Software throttling maintains output data flow at an appropriate rate so that data is not lost, notwithstanding the fact that acknowledgement packets cannot pass through the data diode from the highest security level network or network segment to a selected lower security level network.

When a user of the workstation needs to access information in one of the lower security level networks the user selects the appropriate setting on the switching unit. The connections for input devices for the workstation are routed to a proxy in the selected network. A remotable session is established on an application server in the selected network. The input devices are connected to the remotable session through the proxy in the selected network so that the input devices are operable to control applications running in the remotable session. Output is sent from the remotable session through the proxy in the selected network to a proxy in the highest security level network through a data diode that ensures that information only flows in one direction. Finally, the output is forwarded to a remote session viewer at the workstation. In many cases, a login screen that requests login information from the user is sent when the remotable session is established.

In one embodiment, the proxy software in the diode server for the highest security level network includes a diode handler object for communicating between the server and the data diode that allows information to flow in only one direction, and a proxy server object for interconnecting the diode handler object to the remotable session viewer in the workstation. The proxy software in the other diode servers also includes a diode handler object, but further includes a proxy client object for interconnecting the diode handler object to a remotable session where applications run, and a switch handler object connected to the proxy client object for communicating between the proxy client object and the switching unit.

In one embodiment, the proxy software, and other software that implements aspects of the present invention can be stored on a media. The media can be magnetic such as diskette, tape, or fixed disc, or optical, such as a CD-ROM. Additionally, the software can be supplied via the Internet or some other type of network. Workstations or servers that run the software include a plurality of input/output devices, a connection for the network, a processor, and memory devices that store and execute the software necessary to implement the invention.

### BRIEF DESCRIPTION OF THE DRAWINGS

FIG. 1 is a network block diagram illustrating the various hardware and software elements used to implement one embodiment of the invention and how the elements are interconnected together.

FIG. 2 is a flowchart that illustrates the method of accessing information according to one embodiment of the invention.

FIG. 3 is a block diagram illustrating the structure of the proxy software that resides in lower security level networks according to the invention.

FIG. 4 is a block diagram illustrating the structure of the proxy software that resides in the highest security level network according to the invention.

FIG. 5 is a hardware block diagram of a workstation or server that implements the present invention.

### DETAILED DESCRIPTION OF ONE OR MORE EMBODIMENTS

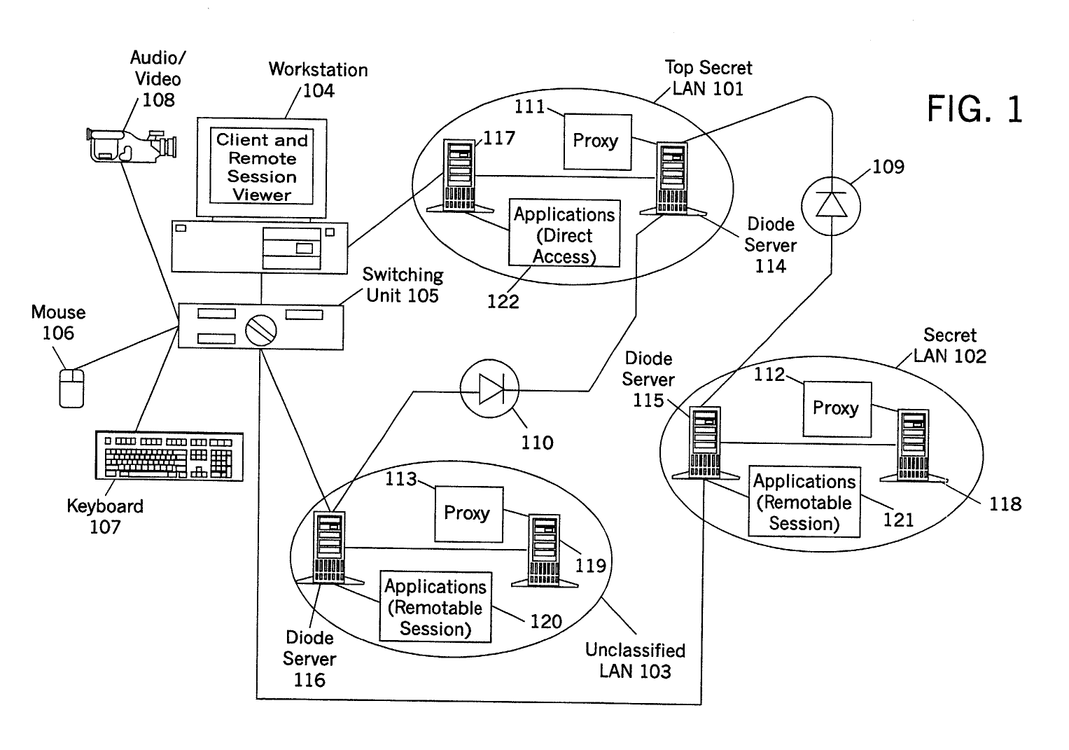

FIG. 1 illustrates the overall network environment according to one embodiment of the present invention. In FIG. 1, three “networks” are shown. These networks can be separate local area networks (LAN's) or some other type of networks. Alternatively, they can be different segments or portions of the same network, however, for convenience, they are illustrated as separate LAN's. Each network is restricted to storing data of a specific security classification. Network 101 contains servers that store “top secret” information and so it is referred to as the top secret LAN; network 102 contains servers that store “secret” information and so it is referred to as the secret LAN; and network 103 contains servers that store unclassified information and so it is referred to as the unclassified LAN. In this example, “top secret” is the highest and most restrictive security classification. It should be noted that I have shown three networks having the traditional government classifications of top secret, secret, and unclassified as an example only. The invention can work with other numbers of networks. It can also work with information classified and stored according to some other industrial or private classification scheme.

The system of the invention enables what is referred to herein as an “ultra-thin enclave client” (UTEC) workstation to allow a user to access information at the different security levels in the different networks. The UTEC client system includes a workstation, 104, connected to a switching unit, 105. Switching unit 105 includes input ports for mouse 106 and keyboard 107. It can optionally also include a port for an audio and/or video source, such as video camera 108. A set of data diodes, 109 and 110, allow information to flow only in one direction. Diode 109 allows information to flow from the secret LAN to the top secret LAN, but not back in the other direction. Diode 110 allows information to flow from the unclassified LAN to the top secret LAN, but not back in the other direction.

The switching unit, 105 of FIG. 1, can be a standard commercial switching unit, for example, a model FID001/S Keyboard Switch Desktop Unit, available from Compaq/Digital Equipment Corporation. This commercially available unit switches only a mouse and keyboard input, and only includes two outputs, although a person of ordinary skill in the art can easily modify such a switch for additional inputs for peripheral devices and additional outputs to support additional networks. The switching until includes software or firmware to allow it to carry out its functions. The data diodes can be commercially available hardware diodes such as model FID003/S Data Diode Device, available from Compaq/Digital Equipment Corporation. These commercial devices are cited as examples only. The data diodes can be implemented by some other hardware. They may also be implemented in software.

A set of software diode proxies that manage the data flow from networks of lower classification to networks of higher classification runs, one each on a diode server within each network. Proxy 111 runs in the highest classification network on diode server 114. Proxy 112 runs, in this embodiment, in the secret network, on diode server 115, and proxy 113 runs in the unclassified network on diode server 116. The proxies also provide an environment where standard, commercial off-the-shelf (COTS) software can run without modifications. In the example of FIG. 1, this COTS software runs on separate application servers 117, 118, and 119, although the application server function and diode server function can be carried out by the same physical server.

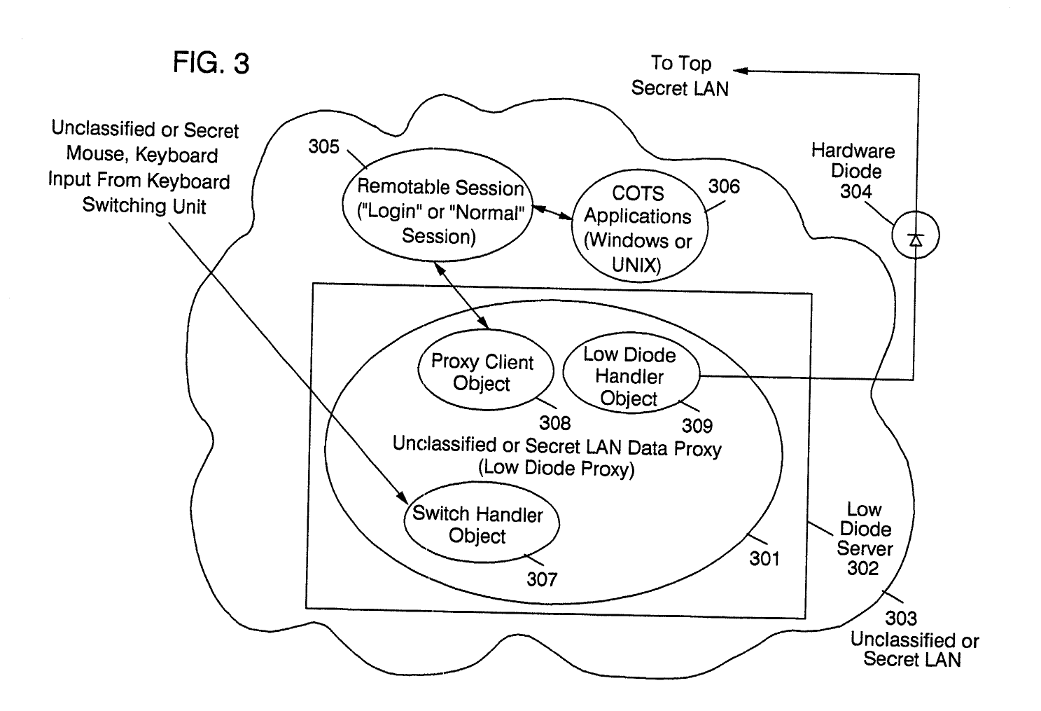

Consideration must be made for the diodes in determining what protocol is used to communicate between the networks through the diodes. Communication between LAN's in network systems where such diodes are not present normally takes place via the well-known transmission control protocol/internet protocol, or TCP/IP. However, TCP, which resides between the IP layer and the application layer is designed for high reliability and redundancy. As such, it requires that acknowledgements be returned whenever a packet is sent. Since the data diodes are one-way devices, acknowledgements cannot be returned when packets are sent from one of the lower classification level networks to the highest classification level network. A different transmission protocol, user datagram protocol (UDP) can be used in lieu of TCP. UDP is covered in Internet Engineering Task Force (IETF) standard Request for Comment (RFC) document number 768, which is incorporated herein by reference. UDP does not require acknowledgements be returned, but does not guarantee the same reliability as TCP. In one embodiment, UDP is used instead of TCP, and reliability is maintained by using software throttling between proxies. With software throttling, packet rates are slowed to match the maximum capabilities of the hardware given the current load. In this way, reliable data transmission is maintained over the one way connection imposed by the data diodes. Software throttling is further discussed in reference to FIG. 3.

In the example embodiment of FIG. 1, the workstation, 104, receives updates continually from all of the networks, so that information that originates from applications running in any of the networks is continually visible on the user's workstation. The user can send input from devices such as the mouse, 106, or keyboard 107 to any of the networks, depending on how the user sets a selector on switching unit 105. If the user sets the selector to unclassified, the inputs are routed to the unclassified network. If the user sets the selector to secret, the inputs are routed to the secret network. If the selector is set to the highest classification (in this example, top secret), then the inputs are routed directly to the user's workstation, 104. The workstation is directly connected to the network of highest classification.

Note that the unclassified LAN and the secret LAN are basically identical in this embodiment; they run the same diode software and are connected through the hardware diodes to the top secret network in the same way. It is also important to note that the invention uses remotable sessions. With a remotable session, applications run and data is stored on a remote system. The workstation simply works as a viewer. Standard, off-the-shelf software such as WinFrame™ from Citrix Systems, Inc. or PCAnywhere™ from Symantec Corporation can be used to run software in remotable sessions. In the example of FIG. 1, applications 120 run in a remotable session on server 119 in the unclassified LAN, and applications 121 run in a remotable session on server 118 in the secret LAN. A prototype system implementing the invention has been built using a well-known program called “VNC” (for “Virtual Network Computer”), that is available from AT&T Cambridge Labs. VNC supports remotable sessions on both Windows™ and Unix™.

Also note that when the inputs are routed directly to workstation 104 by switching unit 105, the top secret network, 101, is accessed. In this case, the proxies and data diodes are not used, and the system operates as though an isolated workstation were accessing only a top secret LAN. In the example of FIG. 1, the workstation accesses applications 122 running on server 117. The remote session viewer can still be used and applications on the top secret LAN can still be run in a remotable session. Or client software on the workstation can access server applications directly, depending on how the top secret network and workstation have been configured.

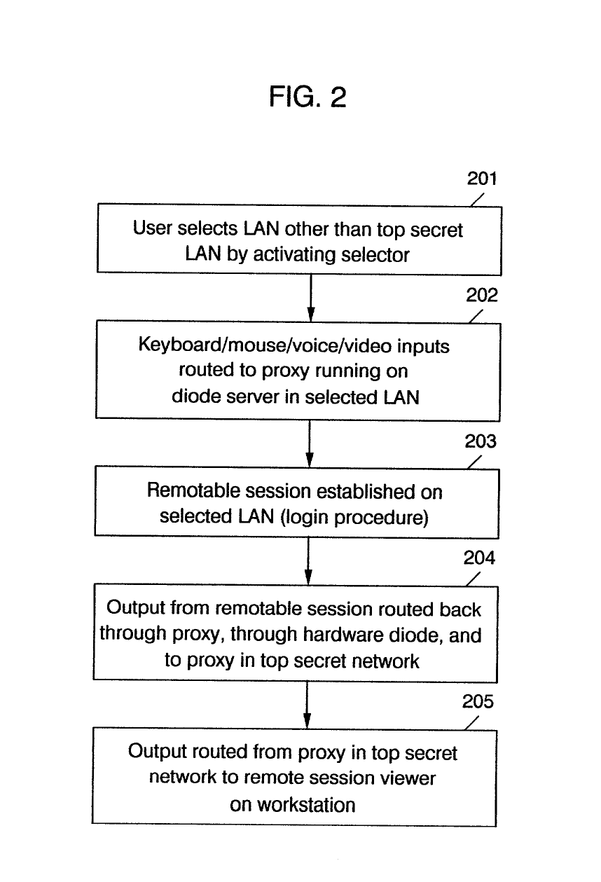

FIG. 2 illustrates the method of initiating a session on one of the lower classification networks according to one embodiment of the invention. Preferably, according to this embodiment, the switching unit is designed so that on power-up, all inputs are automatically connected directly to the workstation so that the top secret network is accessed. At this point a user can run programs using the top secret LAN. If the user wants to do some work on one of the other LAN's, he or she activates a control on the switching unit at step 201 to select the appropriate LAN; for example, he or she selects “SECRET”. Mouse and keyboard input data are no longer routed to the users workstation. Instead, they are routed to the proxy on the secret network at step 202, using the connection between the switching unit and the secret network. In one embodiment, this connection is an Ethernet connection. If the invention is implemented to work with other inputs, for example audio or video, these inputs are rerouted also. At step 203 a remotable session is started in the secret LAN, and output is sent from the secret proxy to the top secret proxy as shown at step 204, and to the workstation, as shown at step 205.

A login program may be initially run by the secret proxy at initialization of the remotable session. If so, the login screen is sent up to the top secret LAN proxy. The top secret LAN proxy sends the screen to the user's workstation. The user uses the mouse and keyboard to type in credentials, and the name of a workstation where a remotable session is to be started. The login program verifies the credentials of the user and allows the login. The login program initiates the remotable session for applications to run on the secret LAN, on the same machine that the user requested during the login process.

From this point forward, the remotable session gets mouse, keyboard, and possibly other inputs from the secret proxy and routes them to the applications. The remotable session gets requests to update screens from the applications and sends these back to the secret LAN proxy. The secret proxy takes these screen updates and sends them to the top secret LAN proxy. The top secret LAN proxy sends the screen updates to the remotable session viewer on the user's workstation. Note that data can only flow in one direction in this example: from the secret LAN to the top secret LAN. Data can never flow in the reverse direction because it is blocked by the data diode. The process described above works the same for any network of less than the highest classification. In the example illustrated in FIG. 1, the process illustrated in FIG. 2 repeats if the user then switches to the unclassified LAN. The same process takes place if the user switches to the unclassified LAN initially.

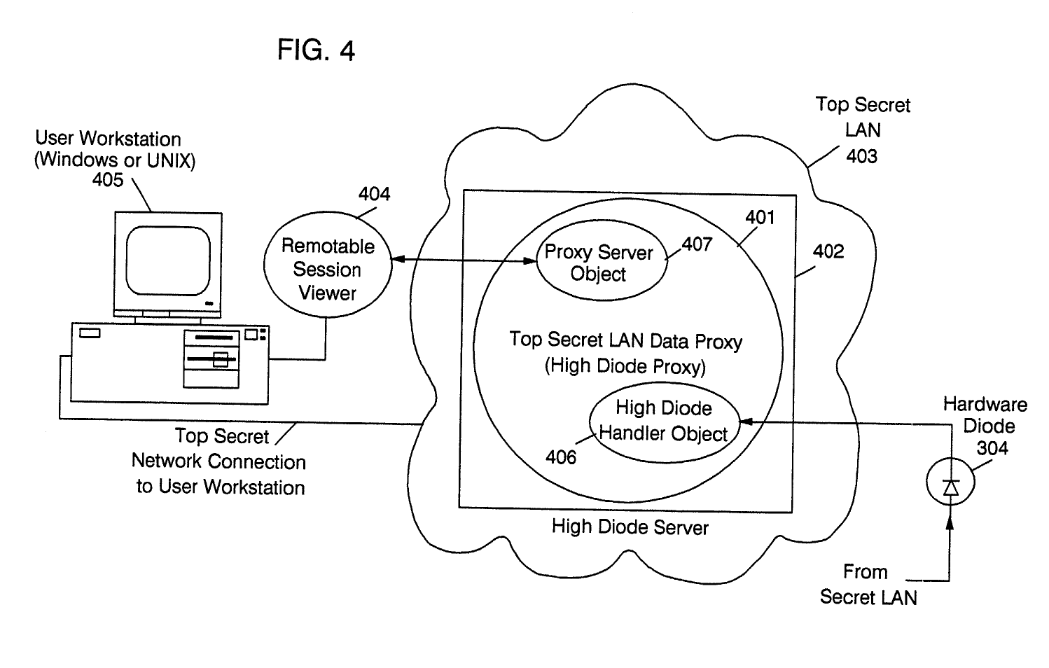

FIGS. 3 and 4 are block diagrams of the proxy software that is installed in the diode servers according to one embodiment of the present invention. The proxy software installed in the two lower classification networks, in the example of FIG. 1, the secret and unclassified LAN's is identical. Throughout this portion of this discussion, I refer to this proxy software as the “low diode” proxy running on the low diode server. The proxy software installed in the highest classification network, the secret LAN, is slightly different. I refer below to the highest classification LAN proxy as the high diode proxy running on the high diode server.

In FIG. 3, low diode proxy 301 runs on low diode server 302 in a secret or unclassified LAN, 303. The LAN, 303, is connected via a data diode, in this example a hardware diode, 304, to the highest classification LAN, in this example, the top secret LAN. A remotable session, 305, which may or may not require login, runs competitive off-the-shelf (COTS) applications, 306, in Windows™ or UNIX™.

Low diode proxy 301 includes a switch handler object, 307. This object is responsible for communicating with the switching unit. In one embodiment, it implements the keyboard switch protocol, which is a TCP/IP-based mouse and keyboard communication protocol. The switch handler object interprets protocol elements as mouse or keyboard events. Based on the event interpretation, it sends messages to either the proxy client object, 308, or the low diode handler object, 309, or both, as appropriate. The keyboard switch protocol, the switch handler object, the proxy client and low diode handler object are described in further detail below.

The keyboard switch protocol is used to communicate between the switching unit and the switch handler object. (The switch handler object will be described in more detail later.) The keyboard switch protocol begins when the switching unit connects to the low diode server (302) on port 4200. The switch handler object is listening for incoming connections on this port.

When the switch handler object receives this incoming connection, it sends back a message that tells the switching unit how to communicate with the switch handler object. This message is described by the following C structure:

typedef struct KBS_init_msg {

| | |
|---|---|
| unsigned int sync; | /* sync pattern: always ‘Oxdeadbeef’ */ |
| unsigned char size; | /* total message size: always 16 */ |
| unsigned char version; | /* protocol version: always 1 */ |
| unsigned char pad[2]; | /* nothing */ |
| unsigned char bodylen; | /* length of body: always 8 */ |
| unsigned char pad2[3]; | /* nothing */ |
| unsigned int host; | /* IP host address of diode server */ |
| unsigned short port; | /* port number of diode server used */ |
| | ** for keyboard messages: always 4201 */ |

} KBS_init_msg_t;

The switch handler object tells the switching unit that it should connect back to the same diode server machine on port 4201 for keyboard messages. The switching unit knows that it should use the next port, 4202, for mouse messages.

The switch handler object is listening for incoming connections along ports 4201 (the keyboard channel port) and 4202 (the mouse channel port). After the switching unit receives the KBS_init_msg packet, it connects to both the keyboard channel port on port 4201 and the mouse channel port on port 4202. At this point, the switching unit can send keyboard or mouse events to the switch handler object.

The switch handler object also continues to monitor port 4200, called the “attention channel”, for any control messages that the switching unit might send it. Messages in this example are described below.

There are four types of keyboard messages that the switching unit sends on the keyboard channel. They are as follows:

Key press: 0th byte=0x00, 1st byte=the keycode associated with the pressed key

Key release: 0th byte=0x01, 1st byte=the keycode associated with the released key

Key done: 0th byte=0x11, 1st byte=0

Switch press: 0th byte=0x04, 1st byte=0. This message indicates that the user pressed a key on the switching unit that will cause future keyboard and mouse events to be sent to this particular switch handler object.

The key press message indicates that the key associated with the given keycode was pressed. The key release message indicates that the key associated with the given keycode was released. The key done message indicates that there are no more key press or key release messages pending for the given keycode.

The last message (the switch press message) warns the switch handler object that the user has just switched to the network—that is, the security level—where the switch handler object resides. In response to this message, the switch handler can take some special action, such as resyncing the entire screen of framebuffer information, when this event occurs.

For each physical key on the user's keyboard, there is a single keycode associated with it. This mapping from physical key to keycode never changes, so a static table in the switch handler object is used to maintain this map. This mapping can be determined easily through inspection of the key press and key release messages in the protocol. The switch handler object never sends any message to the switching unit's keyboard channel.

There is a single 6-byte message that the switching unit sends on the mouse channel for mouse messages:

Mouse message:

| | |
|---|---|
| 0th byte = 0 × 20 | (“begin message” byte) |
| 1st byte = mouse action byte | |
| 2nd byte = 0 × 21 | (“delta X next” byte) |
| 3rd byte = delta X byte | |
| 4th byte = 0 × 22 | (“delta Y next” byte) |
| 5th byte = delta Y byte | |

The mouse action byte is divided as follows:

| bit | 0 | 1 | 2 | 3 | 4 | 5 | 6 | 7 |
|---|---|---|---|---|---|---|---|---|
| value | 0 | 0 | Y dir | X dir | 1 | ctr | rt | left |

That is, bits 0 and 1 are always 0; bit 2 is the Y direction (set to 1 if the mouse is moving upward, 0 downward); bit 3 is the X direction (set to 1 if the mouse is moving to the right, and 0 if moving to the left); bit 4 is always 1; and bits 5 through 7 indicate whether the right, center, or left mouse button was pressed.

For example, if bit 6 is “1”, then the right mouse button is pressed, if bit 6 is “0”, then the right mouse button is not pressed. Bit 4 is always set to 1.

The delta X and delta Y bytes are both integers that indicate the relative motion of the mouse. For example, if the value of the delta X byte is −2, this indicates that the mouse moved to the left 2 units. If the value of the delta Y byte is 5, this indicates that the mouse moved upward 5 units. Note that this implies that the “Y dir” and “X dir” bits in the mouse action byte are actually redundant, since the delta X and delta Y bytes also contain directional information. The switch handler object never sends any message to the Switching Unit's mouse channel.

The switching unit sends control messages on the attention channel. There are two things that can happen on this channel. First, the switching unit can close this channel. This indicates that the switching unit has been turned off, or that its reset button has been pressed (where “reset” means “reboot the switching unit”).

Secondly, the switching unit can send a “heartbeat” message to this channel. The heartbeat message is described by the following C structure:

typedef struct attn_msg {

| | |
|---|---|
| unsigned int sync; | /* always ‘Oxdeadbeef’ */ |
| unsigned int beat; | /* always ‘0x11010000’ */ |
| unsigned int pad[2]; | /* always 0 */ |

} attn_msg_t;

This message is sent by the switching unit every 15 seconds or so to indicate that it is alive and well.

The switch handler object, 307, performs the following routines, which are called as follows:

Start: Initializes the basic configuration of the object, including the software “engine” that implements the mouse and keyboard communication protocol; sets up well-known TCP/IP ports that the switching unit will use. This routine is called when the switch handler object is instantiated.

HandleAttentionConnection: Requests the handling of an “attention” request from the switching unit. This request tells the low diode proxy that the switching unit is preparing to connect all of its input channels to the low diode proxy. This routine then sends a message back to the switching unit telling it what TCP/IP ports it should connect to for keyboard and mouse events.

HandleAttentionData: Requests the handling of data from the attention channel opened during the HandleAttentionConnection routine discussed above. This routine receives “heartbeat” messages from the switching unit (indicating that the unit is still “alive”). It also receives close messages from the switching unit, which indicate to the low diode proxy that the switching unit software has stopped running. This routine takes no action on the heartbeat message. If it receives a “close” message, it cleans up the attributes associated with that particular switching unit and closes the proxy end of the TCP/IP connection to the switching unit.

HandleKeyboardConnection: This routine is invoked whenever the switching unit opens a TCP/IP channel for the purposes of sending keyboard events. The routine sets up a keyboard event handler (see the next routine) and sets the TCP/IP attributes on the keyboard channel so that the TCP/IP channel is “non-blocking”, unbuffered, and does not impose any special meanings on data in the channel effectively establishing a “raw” communications channel.

HandleKeyboardData: This routine is invoked whenever the switching unit has received keyboard inputs from the user. The routine is given the keyboard event as a message. The routine decodes the keyboard event and translates the event to a remotable session protocol element. The routine then invokes the SendinputToServer routine in the proxy client object (see the proxy client object description, below).

HandleMouseConnection: This routine is similar to HandleKeyboardConnection, except it opens a mouse event connection instead of a keyboard connection.

HandleMouseData: This routine is similar to HandleKeyboardData, except it receives and decodes mouse events rather than keyboard events. It also invokes SendInputToServer in the proxy client object.

InitiateLoginSession: This routine is invoked if login is required after the switching unit connects to all of the event channels. The routine sends a message to the StartLogin method of the proxy client object for the purposes of authenticating the user. It also tells the StartLogin method to invoke this object's HandleLogin method (described below) when the login is completed.

HandleLogin: This routine is invoked by the proxy client object after a user is authenticated. It receives a message from the proxy client object that contains the name of the channel that the proxy client object is using to communicate with the remotable session. The switch handler object needs to know this channel in order to associate mouse and keyboard events with the remotable session to which they are to be delivered. This routine also invokes the StartSession handler in the proxy client object, causing a new remotable session to be started on behalf of the new user.

CloseKBSChannel: This routine closes one of the event channels used to communicate with the switching unit. It is called when there is an error on one of the channels, or when so directed by CloseKBSUnit routine discussed below.

CloseKBSUnit: This routine closes all channels associated with a particular switching unit. It is called when an error or “end of file” message is received on the attention channel.

The proxy client object, 308 of FIG. 3, is responsible for the interface between the low diode proxy and the remotable session, 305 in FIG. 3. In one embodiment of the invention, there are actually two different instances of the remotable session: a login remotable session and a normal remotable session. The login remotable session is used solely to authenticate the user. The normal remotable session supports applications.

The proxy client object, 308, performs the following routines:

Start: This routine is invoked when the object is instantiated. It begins listening on a well-known TCP/IP port for authenticating session connections. The login remotable session is responsible for displaying a graphical interface to authenticate the user.

StartLogin: This routine is invoked by the switch handler object to initiate an authentication session with the user. It spawns the login remotable session and connects to it, after a delay sufficient to allow start up. The routine also invokes the SendBindUp message in the low diode handler object. This message is used to notify the high diode proxy that a particular switching unit has been associated with an instance of a remotable session (in this case, the login remotable session).

HandleLoginConnection: This routine is invoked by the login remotable session when it begins the process of authenticating the user. It creates a data handler method, called HandleLoginData, used to obtain authentication information.

HandleLoginData: This routine is invoked when there is authentication data available for a user. The routine is given a message, which includes the user's name, password, and the name of the remotable session for the normal session. This routine verifies the correctness of the information and sends either an acknowledgement, or a negative acknowledgement (nak), back to the login remotable session. It also invokes the previously described HandleLogin routine in the switch handler object.

StartSession: This routine is invoked by the HandleLogin routine in the switch handler object. It spawns a new instance of the remotable session, the normal remotable session, which allows the user to interact with applications. It also calls the SendBindUp routine in the low diode handler object, which notifies the high diode server that this new remotable session is to be bound to the user's switching unit.

HandleRemotableSessionData: This routine is invoked whenever any remotable session sends data to the proxy client object. Where VNC is used for remotable sessions, the routine contains a message that is an element of the VNC protocol, which is used for the exchange of initialization messages, mouse events, keyboard events, and video framebuffer updates. The routine will actually receive only two types of messages: initialization messages, and framebuffer update messages. The SendinputToServer routine below is used for communicating mouse and keyboard events. When a message is received by this routine, the routine in turn invokes the ForwardBytesUp routine in the low diode handler object. This routine is responsible for sending all of this in formation to the high diode server. This routine also contains the throttling capability. This capability is necessary in order to avoid sending data too fast to the high side through the data diode. The throttling capability consists of an algorithm that takes this routine out of service for periods of time, so that the routine does not process any messages from the remotable session. Since no inputs are being received, no output is generated so that the low side avoids overrunning the UDP buffers on the high side. The UDP overruns would otherwise result in reliability problems, since UDP does not have any retransmission or other reliability features like TCP does. While the routine is out of service, the remotable session, or the underlying TCP/IP protocol, will simply queue any data that is intended for the low diode proxy. Therefore, no loss of data will occur.

SendinputToServer: This routine is invoked by the switch handler object whenever mouse or keyboard events are available. The routine forwards these events, which are encoded in the VNC protocol if VNC is used, to the remotable session.

CloseServerChannel: This routine is invoked when it is necessary to close the connection to the remotable session. Closing the connection becomes necessary when there is an error of some kind, or when the connection to the switching unit has been lost.

The low diode handler object, 309 of FIG. 3, is responsible for the interface between the low diode proxy and the hardware diode, 304. The hardware diode enables a one-way communication path between the low diode server and the high diode server, with all data flows going from low to high. Since it is a one-way device, UDP is used for communication instead of TCP, as previously discussed.

The low diode handler object, 309, performs the following routines, which are called as follows:

Start: This routine is invoked when the object is instantiated. It establishes a UDP connection, which is actually an IP binding to a local port that identifies that port with the IP address of the high diode server. The connection is made through the hardware diode to the high diode server.

SendBindUp: This routine is invoked by the proxy client object whenever there is a relationship established between a particular switching unit and a particular remotable session. The high diode server needs to know about this relationship, so this bind message is forwarded to the high side.

ForwardBytesUp: This routine is invoked by the proxy client object when there is remotable session data (such as VNC framebuffer data) available. This routine routes the data to the high diode server, after compressing it using any standard compression algorithm for improved performance. The routine also wraps the message in a header that indicates the message's length and its sequence number, so that the high side will be able to determine if any packets were lost in transmission.

FIG. 4 illustrates the high diode proxy software, 401, which serves as the top secret LAN data proxy in the embodiment illustrated in FIG. 1. The high diode proxy runs on the high diode server, 402 in top secret LAN 403. Hardware diode 304 is the same hardware diode as illustrated in FIG. 3. Remotable session viewer 404 runs on the workstation, 405, in a Windows™ or UNIX™ environment.

High diode proxy 401 includes a high diode handler object, 406. This object is responsible for the interface between the high diode proxy and the data diode, in this example hardware diode 304. The high diode handler object, 406, performs the following routines, which are called as follows:

Start: This routine is invoked when the high diode handler object is instantiated. It invokes the ListenForLowData routine discussed below and initializes a set of accounting variables (including the current and cumulative data arrival rate, the number of packets received, and the number of dropped packets detected).

ListenForLowData: This routine is invoked by the Start method. It opens a well-known UDP port and declares that the HandleLowData routine will be invoked whenever there is UDP data available from the hardware diode. It also sets some attributes for the UDP port so that the UDP channel is “non-blocking”, unbuffered, and does not impose any special meanings on data in the channel effectively establishing a “raw” communications channel.

HandleLowData: This routine is invoked whenever there is UDP data available from the low side via the hardware diode. First, this routine decodes the message from the low side by uncompressing the message and decoding the message header to determine the length of the message and to verify its sequence number. The routine then determines whether the message from the low side is a control message (e.g. the bind message) or if the message is a normal framebuffer message. If the message is a control message, the routine invokes the ProcessLowControlData routine. If the message is a normal message, the routine invokes the proxy server object's ProcessLowData method, sending it the framebuffer message (see below).

ProcessLowControlData: This routine is invoked by the HandleLowData routine when there is control data available from the sow side. Its purpose is to interpret control messages, such as the bind message. When the routine receives a bind message, it creates an association between a switching unit and a remotable session as directed by the data in the bind message. Later, when normal framebuffer messages are received that are from a particular remotable session, the high diode proxy will know to which switching unit, and therefore to which remotable session viewer, to send the data. Finally, the message causes the SpawnRemotableSessionViewer routine in the proxy client object to be invoked, causing the remotable session viewer to be started.

The high diode proxy includes proxy server object 407 of FIG. 4. This object is responsible for the interface between the high diode proxy and the remotable session viewer. Its purpose is to send framebuffers that originated from the remotable session on the low side to the remotable session viewer on the high side. The proxy server object, 407, performs the following routines:

Start: This routine is invoked when the proxy server object is instantiated. It declares that the HandleRemotableViewerConnection routine (see below) should be invoked when an incoming connection from a remotable session viewer is received.

SpawnRemotableSessionViewer This routine is invoked when the ProcessLowControlData routine of the high diode handler object receives a bind message. It causes a remotable session viewer to be spawned on behalf of a particular switching unit. Later, the remotable session viewer will connect back to this object (see HandleRemotableViewerConnection below).

HandleRemotableViewerConnection: This routine is invoked when the remotable session viewer connects to the high diode proxy. It declares that the HandleRemotableViewerData process will be invoked whenever there is a message from the remotable session viewer. It also sets attributes associated with the channel TCP/IP channel so that it is “non-blocking”, unbuffered, and does not impose any special meanings on the data channel effectively establishing a “raw” communications channel.

ProcessLowData: This routine is invoked by the high diode object when there is framebuffer data available from the low side via hardware diode 304. The routine first determines whether there is a valid connection to a remotable session viewer associated with the frame buffer. If not, the routine queues the data and waits until there is a valid remotable session viewer (if the remotable session viewer is being started), or it drops the data (if the remotable session viewer has previously closed due to some error). If there is a valid connection to a remotable session viewer, this method sends the message to the viewer.

HandleRemotableViewerData: This routine is invoked whenever there is a message from the remotable session viewer. If VNC is being used, the remotable session viewer communicates with the VNC protocol. The only messages of interest from the remotable session viewer are protocol startup messages. This routine is responsible for sending appropriate VNC protocol replies back to the remotable session viewer during the startup phase.

CloseRemotableViewerChannel: This routine is invoked whenever the remotable session viewer stops running, or if there is an error detected on the connection to the remotable session viewer. It closes the connection from the high diode proxy's point of view.

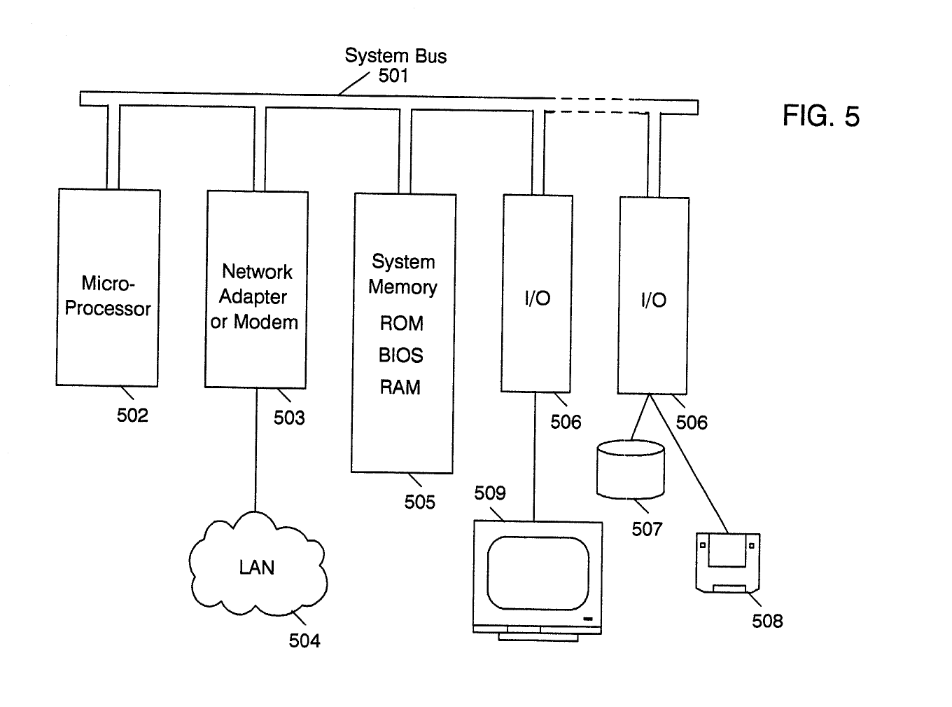

As previously mentioned, much of the software that is used to implement the invention resides on and runs on one or more computer systems, which in one embodiment, are personal computers, workstations, or servers. FIG. 5 illustrates further detail of a computer system that is implementing the invention. System bus 501 interconnects the major components. The system is controlled by microprocessor 502, which serves as the central processing unit (CPU) for the system. System memory 505 is typically divided into multiple types of memory or memory areas, such as read-only memory (ROM), random-access memory (RAM) and others. If the computer system is an IBM compatible personal computer, the system memory also contains a basic input/output system (BIOS). A plurality of general input/output (I/O) adapters or devices, 506, are present. Only two are shown for simplicity. These connect to various devices including a fixed disk, 507, a diskette drive, 508, and a display, 509. The computer program instructions for a proxy and/or a remotable session according to the invention are stored on the fixed disk, 507, and are partially loaded into memory 505 and executed by microprocessor 502. The system also includes another I/O device, a network adapter or modem, shown at 503, for connection to one of the LAN's 504. It should be noted that the system as shown in FIG. 5 is meant as an illustrative example only. Numerous types of general-purpose computer systems are available and can be used to implement the invention. Available systems include those that run operating systems such as Windows™ by Microsoft and various versions of UNIX.

As previously mentioned, appropriate computer program code in combination with the appropriate hardware implements the invention. This computer program code is often stored on storage media. This media can be a diskette, hard disk, CD-ROM, DVD-ROM, or tape. The media can also be a memory storage device or collection of memory storage devices such a read-only memory (ROM) or random access memory (RAM). Additionally, the computer program code can be transferred to a workstation over the Internet or some other type of network. The diskette drive of FIG. 5 is indicated by a drawing of one type of media, a diskette, which can be used to initially transfer some of the computer program code of the invention to the computer system of FIG. 5. A diskette typically includes magnetic media enclosed in a protective jacket. Magnetic field changes over the surface of the magnetic media are used to encode the computer program code.

I have described specific embodiments of an invention, which provides a multilevel secure network access system. One of ordinary skill in the networking and computing arts will quickly recognize that the invention has other applications in other environments. In fact, many embodiments and implementations are possible. The following claims are in no way intended to limit the scope of the invention to the specific embodiments described.

I claim:

1. A method of allowing access by a workstation connected to a first network of a highest security level, to information in a second network of a lower security level, the method comprising the steps of:
routing connections for input devices for the workstation to a proxy in the second network;
establishing a remotable session in the second network;
connecting the input devices to the remotable session through the proxy in the second network so that the input devices are operable to control applications running in the remotable session;
sending output from the remotable session through the proxy in the second network to a proxy in the first network through a diode that ensures that information only flows in one direction; and
forwarding the output from the proxy in the first network to a remote session viewer at the workstation.

2. The method of claim 1 wherein the establishing step includes sending a login screen and further comprising the step of receiving login information for a user at the second network.

3. Apparatus for allowing access by a workstation connected to a first network of a highest security level, to information in a second network of a lower security level, the apparatus comprising:
means for routing connections for input devices for the workstation to a proxy in the second network;
means for establishing a remotable session in the second network;
means for connecting the input devices to the remotable session through the proxy in the second network so that the input devices are operable to control applications running in the remotable session;
means for sending output from the remotable session through the proxy in the second network to a proxy in the first network through a diode that ensures that information only flows in one direction; and
means for forwarding the output from the proxy in the first network to a remote session viewer at the workstation.

4. A system for selectively allowing access by a workstation connected to a plurality of networks to information in a network of the highest security level or in a selected network from one or more other networks of lower security levels, the system comprising:
a switching unit for selectively routing connections for input devices to the workstation or to the selected network;
a plurality of programmable computer systems disposed in the plurality of networks, each of the programmable computer systems operable to execute applications under the control of the workstation;
a plurality of diode servers disposed one each in each of the plurality of networks, each diode server in the one or more other networks connected to the switching unit and at least one programmable computer system and operable as a proxy to connect the switching unit to a remotable session in the selected network, a selected diode server further operable to forward output from the remotable session to the network of the highest security level for display in a remote session viewer at the workstation; and
one or more diodes disposed one each between a diode server in one of the one or more other networks and a diode server in the network of the highest security level so that information can flow only from the selected network to the network of the highest security level.

5. A method of operating a server to proxy access by a workstation connected to a first network of a highest security level, to information in a second network of a lower security level, the method comprising the steps of:
establishing a remotable session in the second network;
connecting the input devices to the remotable session through the server so that the input devices are operable to control applications running in the remotable session; and
sending output from the remotable session to the first network through a diode that ensures that information only flows from the server in the second network to the first network.

6. The method of claim 5 wherein the establishing step includes sending a login screen and further comprising the step of receiving login information for a user at the second network.

7. A computer program product for enabling a server to proxy access by a workstation connected to a first network of a highest security level, to information in a second network of a lower security level, the computer program product including a computer program comprising:
instructions for establishing a remotable session in the second network;
instructions for connecting the input devices to the remotable session through the server so that the input devices are operable to control applications running in the remotable session; and
instructions for sending output from the remotable session to the first network through a diode that ensures that information only flows from the server in the second network to the first network.

8. The computer program product of claim 7 wherein the computer program further comprises instructions sending a login screen and receiving login information for a user at the second network.

9. The computer program product of claim 7 wherein the instructions for sending output further include instructions for software throttling.

10. The computer program product of claim 8 wherein the instructions for sending output further include instructions for software throttling.

11. Apparatus for granting access by a workstation connected to a first network of a highest security level, to information in a second network of a lower security level, the apparatus comprising:
means for establishing a remotable session in the second network;
means for connecting the input devices to the remotable session so that the input devices are operable to control applications running in the remotable session; and
means for sending output from the remotable session to the first network through a diode that ensures that information only flows from the second network to the first network.

12. A programmed computer system which is operable to proxy access by a workstation connected to a first network of a highest security level, to information in a second network of a lower security level by performing the steps of:
establishing a remotable session in the second network;
connecting the input devices to the remotable session through the server so that the input devices are operable to control applications running in the remotable session; and
sending output from the remotable session to the first network through a diode that ensures that information only flows from the server in the second network to the first network.

13. The computer system of claim 12 which is further operable to apply software throttling to the output being sent to the first network.

14. A system for allowing access by a workstation connected to a first network of a highest security level, to information in a second network of a lower security level, the system comprising:
a diode handler object for communicating between the system and a diode that allows information to flow in only one direction; and
a proxy server object for interconnecting the diode handler object to a remotable session viewer in the workstation.

15. A system for allowing access by a workstation connected to a first network of a highest security level, to information in a second network of a lower security level, the system comprising:
a diode handler object for communicating between the system and a diode that allows information to flow in only one direction;
a proxy client object for interconnecting the diode handler object to a remotable session; and
a switch handler object connected to the proxy client object for communicating between the proxy client object and a switching unit.

16. The system of claim 15 wherein the diode handler object applies software throttling to the information.
